(19) United States
(12) Patent Application Publication
(10) Pub. No.: US 2013/0157021 A1
(43) Pub. Date: Jun. 20, 2013

(54) COATED FINE PAPER HAVING A SOFT TOUCH

(71) Applicant: Jean-Marie Baumlin, Anzin Saint-Aubin (FR)

(72) Inventor: Jean-Marie Baumlin, Anzin Saint-Aubin (FR)

(73) Assignee: ARJOWIGGINS FINE PAPERS LIMITED, Manchester (GB)

(21) Appl. No.: 13/701,650

(22) PCT Filed: May 27, 2011
(86) PCT No.: PCT/FR2011/051226

§ 371 Date: Feb. 5, 2013

(30) Foreign Application Priority Data
Jun. 3, 2010 (FR) 1054343

(51) Int. Cl. B41M 5/52

(52) U.S. Cl. CPC B41M 5/52
USPC 428/207; 427/209; 428/342; 428/212; 428/313.9

(57) ABSTRACT

Fine paper for writing, packaging and/or printing, in particular offset printing, comprising a fibrous layer having a bulk greater than or equal to 1.10 cm³/g and at least one coating, said coating having a dry deposition on one or each face of the fibrous layer that is between 3 and 10 g/m² and comprising at least one mineral pigment, at least one latex acting as a binder, and at least one aqueous polyurethane dispersion at a rate of 0.5 to 8% dry weight with respect to the dry weight of pigment(s) of the coating, such that the coated paper has a similar texture to that of the fibrous layer.

The present invention relates to a coated fine paper for writing, packaging and/or printing, in particular offset printing, and the method for the preparation thereof.

### BACKGROUND OF THE INVENTION

In the printing paper industry, papers may be characterised by the use thereof, each use corresponding to clients with a specific type of printer and corresponding to a specific market. A paper industry client thus chooses, from the various papers offered, that most suitable for printing with the type of printer to be used and corresponding best to requirements in terms of quality and cost.

There are a number of types of printer or printing including desktop inkjet, continuous inkjet, black and white offset (for example for printing newspapers), 4-colour offset (quadrichromy), digital offset, thermal offset, electrophotography (photocopier, laser printer), photo-engraving, screen printing and sublimation.

The inks used for paper printing depend on the type of printing. Inks for inkjet printing include volatile solvents or water as a vehicle, whereas inks for offset printing use vegetable oils or petroleum distillates as vehicles.

For 4-colour offset printing, two types of paper may be used: coated papers and fine papers.

A coated paper comprises a conventional paper whereon a coating comprising a binder and pigments is deposited. The paper fibres are thus masked by the coating so as to be no longer visible. The paper serves merely as a support for the coating which is devised so as to give the coated paper a very good printing quality. The paper acting as the support of the coated paper is thus not visible in the end product and may be of relatively low quality.

A coated paper has a low bulk (generally less than 1.04 cm³/g), and the paper pulp used for the manufacture thereof comprises cellulose fibres of varying quality, a binder, and a relatively large quantity of fillers (generally greater than 15% dry weight with respect to the total dry weight of the paper).

The pigmented coating is generally deposited on the support paper at a rate of 18 to 35 g/m² per face, by means of a smoothing coating technique such as a blade, giving the coated paper a flatness masking the imperfections of the paper such as look-through and roughness provided by the fibrous layer of the support paper.

Coated paper is produced at a lower cost with machines measuring several metres wide and running at sheet wrap speeds typically greater than 1000 m/min. The paper first receives a primer which is a first generally pigmented coating deposited in line at a rate of few g/m², receives the abovementioned pigmented coating defining the printability of the end product and is calendered at the end of the line.

On the other hand, a fine paper is a valuable or high-quality paper differing from a conventional paper or support used for preparing a coated paper in particular by the bulk thereof, the paper pulp composition used for the production thereof and the higher production cost thereof. A fine paper is generally naturally marked or textured due to the production method used and/or by means of a treatment applied, such as graining.

A fine paper has a bulk greater than or equal to 1.10 cm³/g, and the paper pulp used for the manufacture thereof comprises high-quality cellulose fibres, a binder, and a small proportion of fillers and/or additives, such as starch.

An important feature of a fine paper is the printability thereof, and particularly the drying time of the inks used for the printing thereof. When a fine paper is printed for example using an offset printing method, it is important for the drying time of the inks used to be relatively brief so that the inks deposited on the recto face of a fine paper do not stain the verso face of another fine paper when stacked on each other, or the same fine paper when rolled up.

The fines papers used in 4-colour offset printing are generally not treated. The inks are deposited directly on the fibres which are only coated with routine additives. In this case, the paper has no pigments on the surface and the paper fibres are visible and clearly distinguished after printing. In particular, the eucalyptus fibres of a fine paper are visible to the naked eye, forming small glossy dots on the surface of the fine paper. The visible textured appearance of the fine paper generates relief on the printed surface and results in a very aesthetically pleasing final rendition after printing the fine paper, which clients appreciate. A further noteworthy difference between a fine paper and a coated paper is that, when a coated paper has some surface roughness, this is due to that coating deposited on the paper, whereas the surface roughness of a fine paper is essentially due to the specific texture thereof.

A fine paper is indeed generally textured or marked, and the texture thereof may be natural and/or forced, i.e. in this case obtained by means of a graining or marking method or by means of an equivalent method. Graining of a fine paper may be carried out during the manufacture of the paper (for example, by means of a suitable cloth for straining the paper pulp or embossing or marking rollers) or thereafter. A grained fine paper comprises hollowed and/or raised patterns on at least one of the faces thereof, for example giving the end product after printing textures such as curved lines or geometric figures. On the other hand, a coated paper has a smooth surface not showing the fibrous layer or marking of the support by an element of the manufacturing method. The fine paper may be laid and comprise laid lines produced for example using an embossed dandy roll.

However, the fine papers according to the prior art suffer from relatively low printing quality, particularly as the drying time of the inks used is very long. Indeed, the fibres of the fine paper do not fix the printing inks sufficiently and thus do not enable the inks to dry quickly. Furthermore, the flatness is not uniform since it is dependent on the fibrous layer of the fine paper which, by the very structure thereof, is not uniform.

Treating a fine paper to enhance the printing qualities thereof, while avoiding masking the surface relief of the paper, has already been suggested. A coating composition comprising pigments and a binder is deposited in this case at a rate of 8 to 16 g/m² on one face of the fine paper to enhance the printability thereof.

However, the coating compositions used in the prior art are not satisfactory particularly since they modify the properties of the coated fine papers with these compositions, and particularly the bulk or mechanical strength and texture thereof.

The mechanical strength of the paper is an important feature for a fine paper. The greater the bulk of a paper, the greater the mechanical strength thereof, and the higher the quality of the fine paper perceived by the client holding the paper in their hands.

However, coating a pigment composition on a fine paper tends to reduce the bulk thereof. Unlike a coated conventional paper, a relatively small amount of this coating composition is thus deposited on a fine paper so that it retains a significant bulk.

The feel or touch is also an important feature of a fine paper. Indeed, the purpose of a fine paper is generally to be held in a client's hands so as to convey information in written or printed form or carry an object for the purposes of packaging. By means of physical contact with the client's hands, sensory information is added to the written message or on holding the packaged object, to form an overall perception of the object.

A fine paper, usually consisting of short cellulose fibres, is characterised in that it has a soft texture. A fine paper consisting of cotton fibres is also very soft. This softness may vary somewhat according to the fibrous composition of the paper, the quantity of fillers used in the paper and the final roughness of the paper. Nonetheless, fine papers are characterised in that they have a soft surface which is particularly pleasant to touch.

However, it has been noted that a fine paper coated with a pigment composition according to the prior art has a texture which is not as soft (rougher) as the same fine paper before coating. In other words, depositing, even in small quantities, a coating composition according to the prior art on a fine paper modifies the touch of this paper, which becomes rougher particularly due to the presence of the pigments of the coating composition.

### SUMMARY OF THE INVENTION

The present invention is suitable for remedying this problem by means of a fine paper coating composition giving this paper a softness similar to that of the paper before coating. The aim thereof is also that of enhancing the printability of a fine paper, particularly by means by offset printing, while retaining the texture thereof.

For this purpose, it relates to a fine paper for writing, packaging and/or printing, in particular offset printing, comprising a fibrous layer having a bulk greater than or equal to 1.10 cm³/g and at least one coating, said coating having a dry deposition on one or each face of the fibrous layer that is between 3 and 10 g/m² and comprising:

at least one mineral pigment,

at least one latex acting as a binder, and

at least one aqueous polyurethane dispersion at a rate of 0.5 to 8% dry weight with respect to the dry weight of pigment(s) of the coating. Due to the aqueous polyurethane dispersion defined, the coated fine paper has a similar texture to that of the fibrous layer.

The definition of a fine paper and the differences between a fine paper and a conventional paper or a coated paper have been detailed above. The fine paper according to the invention has a bulk greater than or equal to 1.10 cm³/g, preferably greater than 1.2 cm³/g, and for example greater than 1.25 cm³/g. It has a thickness between 0.1 and 0.5 mm for example, and preferably between approximately 0.15 and 0.35 mm, and/or a basis weight between 100 and 300 g/m², and preferably between 120 and 240 g/m². The bulk of a fine paper is obtained by means of the ratio of the thickness thereof with respect to the basis weight thereof.

The fibrous layer of the fine paper according to the invention preferably consists of cellulose fibres, a binder, and filler, the quantity thereof is less than 22%, and preferably less than 15%, dry weight with respect to the total dry weight of the paper. Furthermore, it may be textured naturally and/or in a forced manner by means of a method as cited above, and comprise raised and/or hollowed patterns, the abovementioned coating not modifying or making minor modifications to the texture on said face. These patterns are generally at least several tens of microns in size.

The deposit of coating composition on the or each face of the fibrous layer is relatively small (between 3 and 10 g/m², preferably between 5 and 7 g/m², and more preferentially about 5 or 6 g/m²) so as not to mask the texture of the paper and have a small influence on the bulk thereof, and thus retain the tactile, visual and mechanical strength features of the original fibrous layer. Advantageously, the appearance, texture and gloss of the coated fine paper are similar to those of the original fibrous layer. Moreover, after offset printing, the fine paper according to the invention has a satisfactory printing uniformity (due to the lack of mottling).

The presence of mineral pigments of the coating composition makes it possible to enhance the printability of the fine paper, particularly by speeding up the drying time of the inks used during printing.

The mineral pigments are preferably present in a majority (in terms of weight) in the deposited coating. They may represent more than 50% of the weight, preferably between 60 and 95% of the weight, more preferentially between 70 and 90% of the weight, and for example between 80 and 90% of the weight, of the deposited coating. They may be deposited at a rate of 2 to 9 g/m², preferably 4 to 8 g/m², and more preferentially 4 to 7 g/m², on the fibrous layer.

The binder of the or each coating is a latex, for example based on styrene-butadiene copolymer(s) and/or styrene-acrylic copolymer(s). The or each coating may comprise a quantity of latex between 1 and 10% dry weight with respect to the total dry weight of the coating.

The aqueous polyurethane dispersion gives the fine paper the soft touch sought, similar to that of the fine paper before coating. The quantity of this dispersion of the coating is relatively small (0.5 to 8%, preferably 1 to 6%, and more preferentially 1 to 5%, dry weight with respect to the total dry weight of pigment(s) of the coating) since an excessively large quantity of this dispersion would give this coating a tacky surface.

The polyurethane used in the or each layer may consist of diisocyanate and polyether. It is advantageously non-ionic so as to facilitate the mixing thereof with the other constituents of this coating. It preferably has a vitreous transition temperature less than −40° C., and for example about −55° C., so as to have a soft consistency at ambient temperature. The aqueous dispersion of non-ionic polyurethane sold by LAMBERTI under the brand ESACOTE PAD® may be used to prepare the fine paper according to the invention.

The degree of gloss of the or each coated face of the fine paper according to the invention may be between 2 and 7% and preferably between 3 and 6%. It is for example less than 6%. The degree of gloss of the or each coated face of the fine paper after printing may be between approximately 4 and 12%, and preferably between 6 and 9%. It is for example less than 8%. The degree of gloss of the fine paper is measured at 75° according to the Tappi®T480 standard, the printing ink used being a 100% black ink (such as the ink: K+E® NOVAVIT® series “Supreme Bio”).

According to a further feature of the invention, the or each coating comprises calcium carbonate and/or kaolin. Calcium carbonate has the advantage of being relatively inexpensive and providing the fine paper with whiteness. Calcium carbonate is preferably the majority pigment of the coating. The or each coating may comprise 50 to 95%, preferably 60 to 90%, and more preferentially 60 to 70%, dry weight of calcium carbonate with respect to the total dry weight of pigments of the coating. The calcium carbonate sold by IMERYS under the brand CARBITAL® may be used to prepare the fine paper according to the invention.

The or each coating may further comprise talc and/or porous amorphous silica. Talc has the advantage of having a soft texture and enhancing the texture of coated fine paper.

The or each coating may comprise 5 to 50%, preferably 15 to 40%, and more preferentially 20 to 30%, dry weight of talc with respect to the total dry weight of pigments of the coating. The quantity of talc in the or each coating is thus relatively small since an excessively large quantity, for example greater than 50%, would reduce the whiteness of the coating and render said coating excessively glossy. The talc particle size is preferentially between 1 and 5 μm. The talc sold by MONDO MINERALS under the brand FINNTALC® may be used to prepare the fine paper according to the invention.

The or each coating may comprise 1 to 15%, preferably 4 to 12%, and more preferentially 6 to 10%, dry weight of porous amorphous silica with respect to the total dry weight of pigments of the coating. Silica makes it possible to reduce the drying time of inks during printing, in particular offset printing, and give the coated fine paper a similar gloss to that of a non-coated fine paper. The silica sold by GRACE under the brand SYLOID® may be used to prepare the fine paper according to the invention.

The or each coating may further comprise at least one dye, and/or at least one optical brightener, and/or at least one wax, and/or starch, and/or at least one polyvinyl alcohol (as a binder), and/or at least one cross-linking agent, and/or at least one thickener, and/or calcium stearate.

Adding dye and/or optical brightener in the or each coating makes it possible to give the coating a homogeneous colour. Polyvinyl alcohol may be used as a substrate for the optical brightener.

The coating may comprise a quantity of cross-linking agent between 0.2 and 0.6%, preferably between 0.3 and 0.5%, and for example about 0.4%, dry weight with respect to the total weight of the coating. The cross-linking agent may be used for cross-linking latex and/or polyvinyl alcohol and thus enhancing the resistance of the coating, in particular to water.

The coating may comprise a quantity of polyvinyl alcohol between 1 and 10%, preferably between 3 and 8%, and for example between 4 and 6%, dry weight with respect to the total dry weight of the coating. It may comprise a quantity of thickener between 0.8 and 1.2%, and preferably about 0.8-1%, dry weight with respect to the total dry weight of the coating. This thickener may be carboxyl methyl cellulose. It may comprise between 0.3 and 3%, and preferably between 1 and 2%, dry weight of calcium stearate with respect to the total dry weight of pigments of the coating.

Preferably, the paper comprises a coating according to the invention on each of the faces therefore and is thus symmetric.

The fine paper according to the invention preferably comprises at least one coating comprising:

at least 60% dry weight of calcium carbonate and between 4 and 12% dry weight of porous amorphous silica, with respect to the total dry weight of pigments of the coating,

between 1 and 6% dry weight of aqueous polyurethane dispersion with respect to the total dry weight of pigments of the coating, and

between 1 and 10% dry weight of latex with respect to the total dry weight of pigments of the coating.

The or each coating may comprise between 20 and 30% dry weight of talc with respect to the total dry weight of pigments of the coating.

Alternatively, the or each coating comprises at least 90% dry weight of calcium carbonate with respect to the total dry weight of pigments of the coating.

The coated fine paper according to the invention may have a Bendtsen roughness between 50 and 400 ml/min. This roughness is preferably greater than 100 ml/min and/or less than or equal to 200 ml/min.

The present invention also relates to a method for preparing a fine paper as described above, characterised in that it comprises a step consisting of depositing the or each coating on the fibrous layer by means of curtain or air knife coating or using a Meyer bar. The fine paper may be calendered after coating.

Unlike the blade coating technique which compresses the fibrous layer of the fine paper by scraping the coating, the curtain and air knife coating techniques do not smooth the fine paper but merely deposit the coating on the fine paper, with the coating following the texture of the fine paper. The coating deposited by means of these techniques has a more uniform thickness and the outer surface of the coating is not as flat and thus more marked, particularly contributing to the final rendition after printing.

### EXAMPLES

The invention will be understood more clearly and further details, features and advantages of the present invention will emerge more clearly on reading the following description including a number of comparative examples.

Coated fine papers were prepared using Conqueror Velin® fine papers sold by the applicant. A coating composition was deposited on one face of each fine paper, and the coated fine papers obtained were then tested to evaluate the texture thereof and the drying time of the inks after printing. The table hereinafter contains the composition of these coated fine papers and the results obtained from these tests.

| Examples | | | 1 | 2 | 3 | 4 | 5 | 6 | 7 | 8 | 9 |
|---|---|---|---|---|---|---|---|---|---|---|---|
| Fine paper | | | Con- | Con- | Con- | Con- | Con- | Con- | Con- | Con- | Con- |
| | | | queror | queror | queror | queror | queror | queror | queror | queror | queror |
| | | | Velin ® | Velin ® | Velin ® | Velin ® | Velin ® | Velin ® | Velin ® | Velin ® | Velin ® |
| Fine paper | Bulk (cm³/g) | | 1.26 | 1.26 | 1.26 | 1.26 | 1.26 | 1.26 | 1.26 | 1.26 | 1.26 |
| charac- | Bendtsen roughness | | 188 | 188 | 188 | 188 | 188 | 188 | 188 | 188 | 188 |
| teristics | (ml/min) | | | | | | | | | | |
| before | Bekk smoothness (s) | | 24 | 24 | 24 | 24 | 24 | 24 | 24 | 24 | 24 |
| coating | | | | | | | | | | | |
| Coating | Pigments | Calcium | 92 | 92 | 92 | 92 | 92 | 92 | 67 | 63 | 92 |
| com- | | carbonates | | | | | | | | | |
| position | | (parts) | | | | | | | | | |
| | | Porous | 8 | 8 | 8 | 8 | 8 | 8 | 8 | 9 | 8 |
| | | amorphous | | | | | | | | | |
| | | silica (parts) | | | | | | | | | |
| | | Talc (parts) | 0 | 0 | 0 | 0 | 0 | 0 | 25 | 28 | 0 |

| | Binder - styrene acrylic | 7.6 | 7.6 | 7.6 | 7.6 | 7.6 | 7.6 | 5 | 3 | 6.5 |
|---|---|---|---|---|---|---|---|---|---|---|
| | latex (parts) | | | | | | | | | |
| | Polyvinyl alcohol (parts) | 6.1 | 6.1 | 6.1 | 6.1 | 6.1 | 6.1 | 6 | 4 | 5 |
| | Cross-linking agent (parts) | 0.5 | 0.5 | 0.5 | 0.5 | 0.5 | 0.5 | 0.5 | 0.5 | 0.45 |
| | Calcium stearate (parts) | 0 | 0 | 0 | 0 | 0 | 0 | 1 | 2 | 0 |
| | Thickener - carboxyl | 1.2 | 1.2 | 1.2 | 1.2 | 1.2 | 1.2 | 1 | 1 | 1 |
| | methyl cellulose (parts) | | | | | | | | | |
| | Wax 1 - Tego glide 100 | 0 | 1 | 0 | 0 | 0 | 0 | 0 | 0 | 0 |
| | (parts) | | | | | | | | | |
| | Wax 2 - Ultralube E162 | 0 | 0 | 1 | 2 | 0 | 0 | 0 | 0 | 0 |
| | (parts) | | | | | | | | | |
| | Aqueous polyurethane | 0 | 0 | 0 | 0 | 2 | 4 | 3 | 6 | 0 |
| | dispersion - | | | | | | | | | |
| | ESACOTE PAD ® (parts) | | | | | | | | | |
| Total coating weight (g/m²) | | 5 | 5 | 5 | 5 | 5 | 5 | 6 | 6 | 10 |
| Coating technique | | Meyer | Meyer | Meyer | Meyer | Meyer | Meyer | air | air | air |
| | | bar | bar | bar | bar | bar | bar | knife | knife | knife |
| Fine paper | Bulk (cm³/g) | 1.37 | 1.33 | 1.33 | 1.33 | 1.33 | 1.33 | 1.17 | 1.19 | 1.23 |
| charac- | Bendtsen roughness | 197 | 195 | 281 | 258 | 188 | 182 | 185 | 189 | 240 |
| teristics | (ml/min) | | | | | | | | | |
| after | Bekk smoothness (s) | 18 | 20 | 20 | 19 | 23 | 23 | 26 | 32 | 21 |
| coating | Fine paper gloss (%) | 3.9 | 3.6 | 3.4 | 3.4 | 4.1 | 3.9 | 4.1 | 3.7 | 3.0 |
| | Texture | ≠ | ≠ | ≠ | ≠ | = | = | = | = | ≠ |
| | ≠: different to fine paper | | | | | | | | | |
| | base (somewhat rough) | | | | | | | | | |
| | =: similar to fine paper | | | | | | | | | |
| | base (soft) | | | | | | | | | |
| | Printability - | | | | | | | good | good | good |
| | 4-colour offset | | | | | | | | | |

| | | | |
|---|---|---|---|
| Fine paper gloss after printing (%) | 5.3 | 5.8 | 6.2 |

The gloss of a non-coated Conqueror Velin® fine paper (fibrous layer) is between 5 and 7%. The gloss of this paper after printing (with 100% black printing ink, density 1.5, such as the ink: K+E® NOVAVIT® “Supreme Bio” series) is between 6 and 9%. The dynamic friction coefficient of each face of the fine paper was measured according to the NF-Q-03-082 standard with a 200 g pad, and is 0.86.

Examples 1 to 4 relate to coated fine papers not covered by the invention.

The coating deposited on the fine paper in each of these examples comprises calcium carbonates (as a majority) and porous amorphous silica as mineral pigments. Each coating comprises a latex as a binder, polyvinyl alcohol, a cross-linking agent and a thickener. The coatings in examples 1 to 4 are devoid of an aqueous polyurethane dispersion and comprise a wax suitable for enhancing the insertion of the fine papers in finishing machines.

The quantity of coating deposited on one face of each fine paper is 5 g/m².

It was observed manually that the texture of the coated fine papers obtained was different to that of the original fine papers or fibrous layers.

This difference in texture can be seen in the differences in Bendtsen roughness and Bekk smoothness between the fibrous layers and the coated fine papers.

The coating of the fine papers in examples 1 to 4 gives rise to an increase in the roughness thereof, significantly in the case of examples 3 and 4 (increase greater than or equal to 70 ml/min after coating).

The Bekk smoothness of the fine papers decreased relatively significantly after coating (from 24 to 18 s in the case of example 1), conveying an increase in the roughness of these fine papers.

The relatively significant increase in the roughness of the fine papers after coating in the case of examples 1 to 4 (illustrated by the increase in the Bendtsen roughness thereof or the decrease in the Bekk smoothness thereof) conveys a modification of the texture thereof.

Examples 5 to 8 relate to coated fine papers according to the invention.

The coatings deposited on the fine papers comprise calcium carbonates and porous amorphous silica as mineral pigments in examples and 6, and also talc in examples 7 and 8.

The coatings in examples 5 and 6 comprise a latex as a binder, polyvinyl alcohol, a cross-linking agent, a thickener, and an aqueous polyurethane dispersion. The coatings in examples 7 and 8 further comprise calcium stearate.

The quantity of coating deposited on one face of each fine paper is 5 or 6 g/m² in examples 5 to 8.

The presence of the aqueous polyurethane dispersion in the pigmented coatings gives the coated fine papers in examples 5 to 8 a soft texture very similar to that of the original fine papers. Moreover, the quality of the 4-colour offset printing of these coated fine papers is high in the case of examples 7 and 8. The dynamic friction coefficient of the coated fine paper in example 7 is 0.67 (measured according to the NF-Q-03-082 standard with a 200 g block).

The Bendtsen roughness of the fine papers in examples 5 to 8 is subject to little or no modification after coating (increase of at most 1 ml/min in example 8, or decrease, after coating). Furthermore, the Bekk smoothness of these papers decreased to a small extent after coating in the case of examples 5 and 6 and even increased in the case of examples 7 and 8. This increase in the Bekk smoothness in the case of examples 7 and 8 could be explained by the coating technique used, which is the air knife.

The small differences between the roughness or the smoothness of the fine papers before and after coating in examples 5 to 8 mean that the textures of the coated papers are similar to those of the original fibrous layers.

Example 9 relates to a coated fine paper outside the scope of the invention.

The coating deposited on the fine paper does not comprise an aqueous polyurethane dispersion, and the coated fine paper obtained has a different texture to the fine paper base (illustrated by a significant increase in the Bendtsen roughness thereof by 52 ml/min).

In conclusion, the coated fine papers according to the invention has a similar Bendtsen roughness and Bekk smoothness to those of the non-coated fine papers or fibrous layers and thus retain the original soft texture thereof.

1. A fine paper for writing, packaging and/or printing, comprising a fibrous layer having a bulk greater than or equal to 1.10 cm³/g and at least one coating, said coating having a dry deposition on one or each face of the fibrous layer that is between 3 and 10 g/m² and comprising:
at least one mineral pigment,
at least one latex acting as a binder, and
at least one aqueous polyurethane dispersion at a rate of 0.5 to 8% dry weight with respect to the dry weight of pigment(s) of the layer.

2. The fine paper according to claim 1, wherein the or each coating comprises calcium carbonate and/or kaolin.

3. The fine paper according to claim 2, wherein the or each coating comprises 50 to 95% dry weight of calcium carbonate with respect to the total dry weight of pigments of the coating.

4. The fine paper according to claim 2, wherein the or each coating further comprises talc and/or porous amorphous silica.

5. The fine paper according to claim 4, wherein the or each coating comprises 5 to 50% dry weight of talc with respect to the total dry weight of pigments of the coating.

6. The fine paper according to claim 4, wherein the or each coating comprises 1 to 15% dry weight of porous amorphous silica with respect to the total dry weight of pigments of the coating.

7. The fine paper according to claim 1, wherein the or each coating further comprises at least one dye, and/or at least one optical brightener, and/or at least one wax, and/or starch, and/or at least one polyvinyl alcohol, and/or at least one cross-linking agent, and/or at least one thickener.

8. The fine paper according to any one of the above claims, characterised in that the or each coating comprises calcium stearate at a rate between 0.3 and 3% dry weight with respect to the total dry weight of pigment(s) of the coating.

9. The fine paper according to claim 1, wherein the dry deposition of the or each coating is between 5 and 7 g/m².

10. The fine paper according to claim 1, wherein the aqueous polyurethane dispersion is present in the or each coating at a rate of 1 to 6% dry weight with respect to the total dry weight of pigment(s).

11. The fine paper according to claim 1, wherein the aqueous polyurethane dispersion is an aqueous non-ionic polyurethane dispersion.

12. The paper according to claim 1, wherein the or each coating comprises:
at least 60% dry weight of calcium carbonate and between 4 and 12% dry weight of porous amorphous silica, with respect to the total dry weight of pigments of the coating,
between 1 and 6% dry weight of aqueous polyurethane dispersion with respect to the total dry weight of pigments of the coating, and
between 1 and 10% dry weight of latex with respect to the total dry weight of pigments of the coating.

13. The fine paper according to claim 12, wherein the or each coating comprises between 20 and 30% dry weight of talc with respect to the total dry weight of pigments of the coating.

14. The fine paper according to claim 12, wherein the or each coating comprises at least 90% dry weight of calcium carbonate and not more than 10% dry weight of porous amorphous silica, with respect to the total dry weight of pigments of the coating.

15. The fine paper according to claim 1, which has on the or each coated face thereof a degree of gloss between 2 and 7%.

16. The fine paper according to claim 1, wherein the coated face thereof or each coated face thereof is printed with and has a degree of gloss after printing between 6 and 9%.

17. A method for preparing fine paper according to claim 1, which comprises a step consisting of depositing the or each coating on the fibrous layer by means of curtain or air knife coating or using a Meyer bar.

18. The method according to claim 17, wherein the fine paper is calendered after coating.
